(19) United States
(12) Patent Application Publication
(10) Pub. No.: US 2018/0365752 A1
(43) Pub. Date: Dec. 20, 2018

(54) SYSTEMS AND METHODS FOR PROFILING USERS AND RECOMMENDING TIRES

(71) Applicant: Rubbr Automotive Services, LLC, Indianapolis, IN (US)

(72) Inventors: Douglas Wilson, Indianapolis, IN (US); Robert Vogt, Indianapolis, IN (US); Colin Gallagher, Indianapolis, IN (US); Loré Hunsicker, Indianapolis, IN (US); Chris Houska, Indianapolis, IN (US); Garth Boes, Indianapolis, IN (US)

(21) Appl. No.: 16/013,493

(22) Filed: Jun. 20, 2018

Related U.S. Application Data
(60) Provisional application No. 62/522,289, filed on Jun. 20, 2017.

(51) Int. Cl. G06Q 30/06; G06N 5/04

(52) U.S. Cl. CPC G06Q 30/0631; G06N 5/048

(57) ABSTRACT

The disclosed systems and methods relate to profiling users and recommending tires, and, more particularly, for systems and methods for determining the most appropriate tires for a customer based on fitment, location, and the customer's personal preferences. In some example embodiments, system may according to the present disclosure determine the most appropriate tires for a customer based on the customer's personal preferences, fitment, and location. In some embodiments, the system may provide a quiz (or “persona selection”) to the customer and, based on the findings provided by the quiz, return a data set tailored to the driving style and product preferences of the customer (or user). The data set may then be used to determine the most appropriate tire for the customer.

### CROSS-REFERENCE TO RELATED APPLICATIONS

This application claims priority and a benefit under 35 U.S.C. § 119(e) of U.S. Provisional Patent Application 62/522,289, filed 20 Jun. 2017. The disclosures of this prior application are hereby incorporated by reference as if fully set forth below.

### TECHNICAL FIELD

Aspects of the present disclosure relate to a systems and methods for profiling users and recommending tires, and, more particularly, for systems and methods for determining the most appropriate tires for a customer based on fitment, location, and the customer's personal preferences.

### BACKGROUND

Traditionally when a customer needs new tires, they go to a tire retailer, give the clerk their vehicle information, and are presented with a list of available options. Because the average consumer has very little knowledge of varying types of tires, they typically rely on a combination of advice from the sales clerk and the price point they are comfortable with paying. Because a sales clerk is unlikely to gather all relevant information about a driver and because there are likely multiple suitable options available at a given price point, such a model is unlikely to land a consumer with the best tire for their needs. Further, should problems ever arise with a consumer's tires, such a model may lead to distrust from consumers as their have to heavily rely on a clerk to inform their purchase.

### BRIEF DESCRIPTION OF THE FIGURES

Reference now will be made to the accompanying figures, which are not necessarily drawn to scale, and wherein:

FIG. 1 is a diagram of an exemplary system that may be used to profile users and recommend tires to purchase.

FIG. 2 is a component diagram of an exemplary recommendation device.

FIG. 3 is a component diagram of an exemplary user device.

FIG. 4 is a flowchart of an exemplary system for profiling users and recommending tires to purchase.

FIGS. 5A-5E depict an example implementation of an exemplary for profiling users and recommending tires to purchase.

FIG. 6 depicts resulting metrics of an exemplary system for profiling users and recommending tires to purchase.

### DETAILED DESCRIPTION

Aspects of the present disclosure relate to systems and methods for allowing consumers to be more involved in the tire purchasing process. The disclosed systems and methods allow consumers to be better informed while also allowing them to provide more relevant information to merchants so that merchants can provide appropriate product recommendations.

The present disclosure can be understood more readily by reference to the following detailed description of exemplary embodiments and the examples included herein. Before the exemplary embodiments of the devices and methods according to the present disclosure are disclosed and described, it is to be understood that embodiments are not limited to those described within this disclosure. Numerous modifications and variations therein will be apparent to those skilled in the art and remain within the scope of the disclosure. It is also to be understood that the terminology used herein is for the purpose of describing specific embodiments only and is not intended to be limiting. Some embodiments of the disclosed technology will be described more fully hereinafter with reference to the accompanying drawings. This disclosed technology may, however, be embodied in many different forms and should not be construed as limited to the embodiments set forth therein.

In the following description, numerous specific details are set forth. But it is to be understood that embodiments of the disclosed technology may be practiced without these specific details. In other instances, well-known methods, structures, and techniques have not been shown in detail in order not to obscure an understanding of this description. References to “one embodiment,” “an embodiment,” “example embodiment,” “some embodiments,” “certain embodiments,” “various embodiments,” etc., indicate that the embodiment(s) of the disclosed technology so described may include a particular feature, structure, or characteristic, but not every embodiment necessarily includes the particular feature, structure, or characteristic. Further, repeated use of the phrase “in one embodiment” does not necessarily refer to the same embodiment, although it may.

Unless otherwise noted, the terms used herein are to be understood according to conventional usage by those of ordinary skill in the relevant art. In addition to any definitions of terms provided below, it is to be understood that as used in the specification and in the claims, “a” or “an” can mean one or more, depending upon the context in which it is used. Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Also, in describing the exemplary embodiments, terminology will be resorted to for the sake of clarity. It is intended that each term contemplates its broadest meaning as understood by those skilled in the art and includes all technical equivalents that operate in a similar manner to accomplish a similar purpose.

To facilitate an understanding of the principles and features of the embodiments of the present disclosure, exemplary embodiments are explained hereinafter with reference to their implementation in an illustrative embodiment. Such illustrative embodiments are not, however, intended to be limiting.

The materials described hereinafter as making up the various elements of the embodiments of the present disclosure are intended to be illustrative and not restrictive. Many suitable materials that would perform the same or a similar function as the materials described herein are intended to be embraced within the scope of the example embodiments. Such other materials not described herein can include, but are not limited to, materials that are developed after the time of the development of the disclosed technology, for example.

Embodiments of the disclosed technology include systems and methods for profiling users and making recommendations for tires to purchase based on the user profile. In certain embodiments, a recommendation device, according to the present disclosure, may use a proprietary algorithm to determine the most appropriate tires for a customer based on fitment, location, and the customer's personal preferences. Further, recommendation device may provide a quiz to the customer and, based on the findings provided by the quiz, return a data set tailored to the driving style and product preferences of the customer (or user).

Throughout this disclosure, certain embodiments are described in exemplary fashion in relation to profiling users and making recommendations for tires to purchase. But embodiments of the disclosed technology are not so limited. In some embodiments, the disclosed technique may be effective in profiling users and making recommendations for other types of purchases as well.

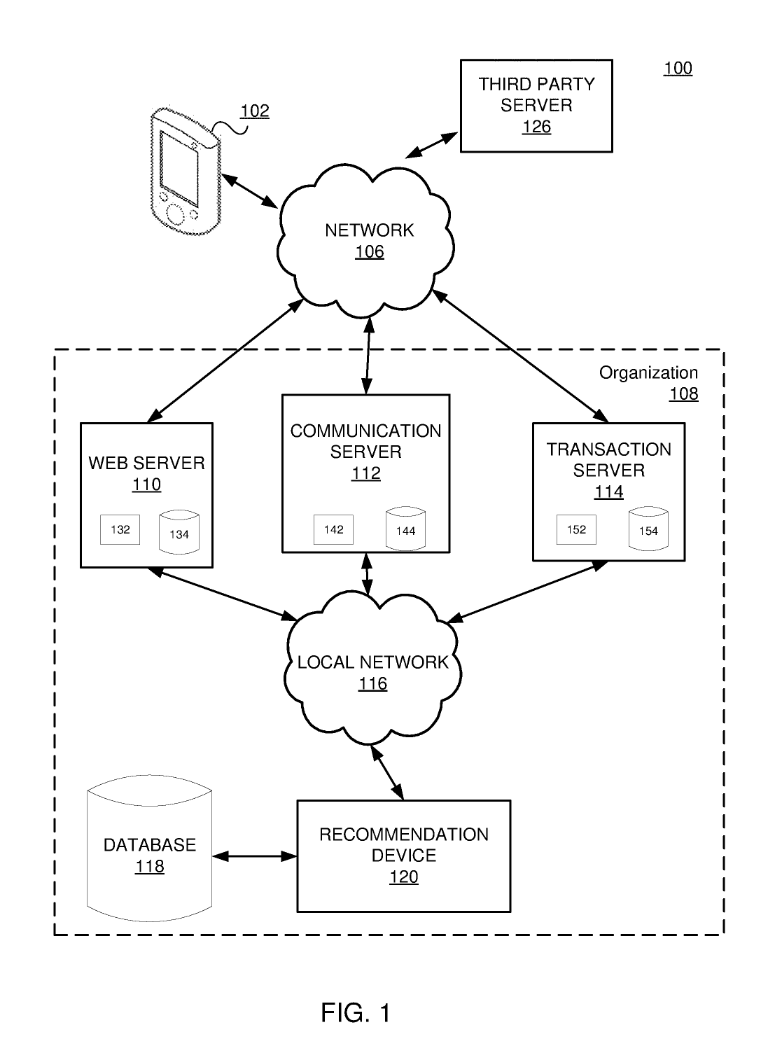

Referring now to the drawings, FIG. 1 is a diagram of an exemplary system 100 that may be configured to perform one or more processes that can provide for profiling users or customers and recommending tires for purchase. The components and arrangements shown in FIG. 1 are not intended to limit the disclosed embodiments as the components used to implement the disclosed processes and features may vary. As shown, system 100 may include a user device 102, a third-party server 126, a network 106, and an organization 108 that may include and make use of, for example, a web server 110, a communication server 112, a transaction server 114, a local network 116, a recommendation device 120, and a database 118.

In some embodiments, a customer may operate user device 102. User device 102 can include one of a mobile device, smart phone, general-purpose computer, tablet computer, laptop computer, telephone, PSTN landline, smart wearable device, voice command device, other mobile computing device, or any other device capable of communicating with network 106 and ultimately communicating with one or more components of organization 108 or with third-party server 126. In some embodiments, user device 102 may include or incorporate electronic communication devices for hearing or vision impaired users. User device 102 may belong to or be provide by a customer, or may be borrowed, rented, or shared. Customers may include individuals such as, for example, subscribers, clients, prospective clients, or customers of organization 108, such as individuals who have obtained, will obtain, or may obtain a product, service, or consultation from organization 108. According to some embodiments, user device 102 may include a microphone and/or digital camera, a geographic location sensor for determining the location of the device, an input/output device such as a transceiver for sending and receiving data, a display for displaying digital images, one or more processors, and a memory in communication with the one or more processors.

Network 106 may be of any suitable type, including individual connections via the internet such as cellular or WiFi networks. In some embodiments, network 106 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

Network 106 may comprise any type of computer networking arrangement used to exchange data. For example, network 106 may be the Internet, a private data network, virtual private network using a public network, and/or other suitable connection(s) that enables components in system environment 100 to send and receive information between the components of system 100. Network 106 may also include a public switched telephone network (“PSTN”) and/or a wireless network.

Third-party server 126 may comprise a computer system associated with an entity other than organization 108 and customers that performs one or more functions associated with the individual and organization 108. For example, in some embodiments, third-party server 126 may comprise an inventory management server that allows organization 108 to determine availability of tires in a given location. In some embodiments, third-party server 126 may comprise a weather server that allows organization 108 to determine current and historical weather patterns in a given location.

Organization 108 may include an entity such as a business, corporation, individual, partnership, or any other entity that provides one or more of goods, services, and consultations to individuals such as customers. As shown in FIG. 1, organization 108 may include one or more servers (e.g., 110, 112, and 114) and computer systems (e.g., 120) for performing one or more functions associated with products and/or services that organization 108 provides. Such servers and computer systems may include, for example, web server 110, communication server 112, and/or transaction server 114, as well as any other computer systems necessary to accomplish tasks associated with organization 108 or the needs of customers.

Web server 110 may include a computer system configured to generate and provide one or more websites or mobile applications accessible to customers, as well as any other individuals involved in organization 108′s normal operations. Web server 110 may have one or more processors 132 and one or more web server databases 134, which may be any suitable repository of website or mobile application data. Information stored in web server 110 may be accessed (e.g., retrieved, updated, and added to) via local network 116 and/or network 106 by one or more devices (e.g., recommendation device 120 or user device 102) of system 100. In some embodiments, processor 132 may be used to implement a website or mobile application that may provide for profiling users and making tire recommendations based on the profiles.

Communication server 112 may include a computer system configured to receive, process, generate, and transmit electronic communications between a customer operating user device 102, and any other computer systems necessary to accomplish tasks associated with organization 108 or the needs of customers. Communication server 112 may have one or more processors 142 and one or more communication databases 144, which may be any suitable repository of communication data. Information stored in communication server 112 may be accessed (e.g., retrieved, updated, and added to) via local network 116 and/or network 106 by one or more devices (e.g., recommendation device 120) of system 100.

Transaction server 114 may include a computer system configured to process one or more transactions involving an account associated with customers, or a request received from customers. In some embodiments, transactions can include, for example, a product/service purchase, product/service return, financial transfer, financial deposit, financial withdrawal, financial credit, financial debit, dispute request, warranty coverage request, and any other type of transaction associated with the products and/or services that organization 108 provides to individuals such as customers. Transaction server 114 may have one or more processors 152 and one or more transaction server databases 154, which may be any suitable repository of transaction data. Information stored in transaction server 114 may be accessed (e.g., retrieved, updated, and added to) via local network 116 and/or network 106 by one or more devices (e.g., recommendation device 120) of system 100.

In some embodiments, transaction server 114 may track and store event data regarding interactions between user device 102 and organization 108, on behalf of the user of the user device. For example, transaction server 114 may track user interactions such as user survey responses, user purchase requests, user purchases, and any other type of interaction that third-party server 126 may conduct with organization 108 on behalf of an individual such as customer.

Local network 116 may comprise any type of computer networking arrangement used to exchange data in a localized area, such as WiFi, Bluetooth™, Ethernet, and other suitable network connections that enable components of organization 108 to interact with one another and to connect to network 106 for interacting with components in system environment 100. In some embodiments, local network 116 may comprise an interface for communicating with or linking to network 106. In other embodiments, components of organization 108 may communicate via network 106, without a separate local network 116.

Recommendation device 120 may comprise one or more computer systems configured to compile data from a plurality of sources (e.g., user device 102, web server 110, communication server 112, and transaction server 114), correlate compiled data, analyze the compiled data, arrange the compiled data, generate derived data based on the compiled data, and storing the compiled and derived in a database such as database 118. According to some embodiments, database 118 may be a database associated with organization 108 that stores a variety of information relating to customers, transactions, and business operations. Database 118 may also serve as a back-up storage device and may contain data and information that is also stored on, for example, databases 134, 144, 154, 260, 270, and 280. Database 118 may be accessed by recommendation device 120 and may be used to store lists of potential tires, information about tires, as well as information about users that is associated with user accounts.

Although the preceding description describes various functions of a web server 110, communication server 112, transaction server 114, authentication device 120, and database 118, in some embodiments, some or all of these functions may be carried out by a single computing device.

According to some embodiments, system 100 may include a software program to implement some or all of the functions of the invention. For example, in some embodiments, user device 102 may store and execute a software program that may interface with and obtain real-time data on the customer status, products, local weather/events (e.g., average weather for customer's location), nearby landmarks, public records relating to the customer or their location, and other such information from other devices (e.g., user device 102, recommendation device 120) to ultimately allow for profiling users and recommending tires for purchase. It will be appreciated by those of skill in the art that although the software is described herein as residing on the user device 102, in various embodiments the software program may reside on any number of other devices, such as for example, the web server 110, communication server 112, transaction server 114, or recommendation device 120.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general-purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high-level and/or low-level software instructions, such as machine code (e.g., such as that produced by a compiler) and/or high-level code that can be executed by a processor using an interpreter

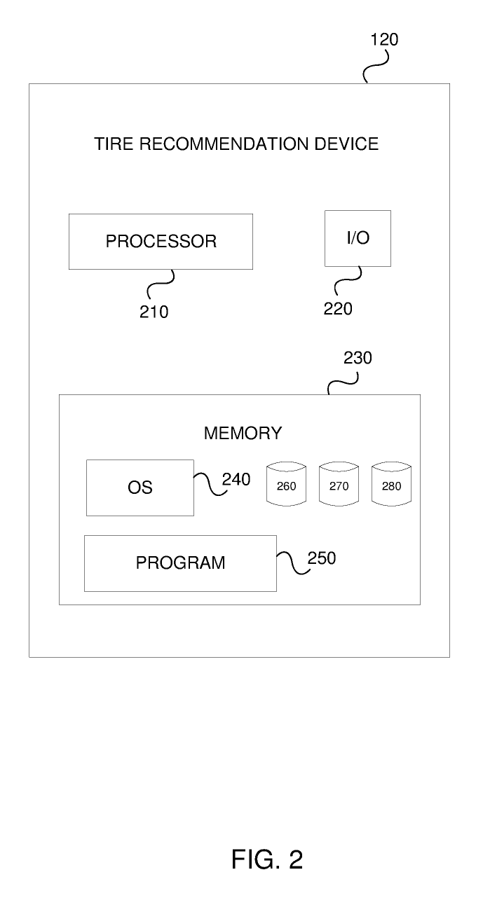

An exemplary embodiment of recommendation device 120 is shown in more detail in FIG. 2. User device 102, web server 110, communication server 112, transaction server 114, and third-party server 126 may have a similar structure and components that are similar to those described with respect to recommendation device 120. As shown, recommendation device 120 may include a processor 210, an input/output (“I/O”) device 220, a memory 230 containing an operating system (“OS”) 240 and a program 250. For example, recommendation device 120 may be a single server or may be configured as a distributed computer system including multiple servers or computers that interoperate to perform one or more of the processes and functionalities associated with the disclosed embodiments. In some embodiments, the recommendation device 120 may further include a peripheral interface, a transceiver, a mobile network interface in communication with the processor 210, a bus configured to facilitate communication between the various components of the recommendation device 120, and a power source configured to power one or more components of the recommendation device 120.

A peripheral interface may include the hardware, firmware and/or software that enables communication with various peripheral devices, such as media drives (e.g., magnetic disk, solid state, or optical disk drives), other processing devices, or any other input source used in connection with the instant techniques. In some embodiments, a peripheral interface may include a serial port, a parallel port, a general purpose input and output (GPIO) port, a game port, a universal serial bus (USB), a micro-USB port, a high definition multimedia (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area network. In some embodiments, a mobile network interface may include hardware, firmware, and/or software that allows the processor(s) 210 to communicate with other devices via wired or wireless networks, whether local or wide area, private or public, as known in the art. A power source may be configured to provide an appropriate alternating current (AC) or direct current (DC) to power components.

Processor 210 may include one or more of a microprocessor, microcontroller, digital signal processor, co-processor or the like or combinations thereof capable of executing stored instructions and operating upon stored data. In some embodiments, processor 210 may be an application or recommendation processor that may execute profiling processes, recommendation processes, or other processes necessary for running an application associated with the organization 108 on the user device 102. Memory 230 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein are implemented as a combination of executable instructions and data within the memory 230.

Processor 210 may be one or more known processing devices, such as a microprocessor from the Pentium™ family manufactured by Intel™ or the Turion™ family manufactured by AMD™. Processor 210 may constitute a single core or multiple core processor that executes parallel processes simultaneously. For example, processor 210 may be a single core processor that is configured with virtual processing technologies. In certain embodiments, processor 210 may use logical processors to simultaneously execute and control multiple processes. Processor 210 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

Recommendation device 120 may include one or more storage devices configured to store information used by processor 210 (or other components) to perform certain functions related to the disclosed embodiments. In one example, recommendation device 120 may include memory 230 that includes instructions to enable processor 210 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, recommendation device 120 may include memory 230 that includes instructions that, when executed by processor 210, perform one or more processes consistent with the functionalities disclosed herein. Methods, systems, and articles of manufacture consistent with disclosed embodiments are not limited to separate programs or computers configured to perform dedicated tasks. For example, recommendation device 120 may include memory 230 that may include one or more programs 250 to perform one or more functions of the disclosed embodiments. Moreover, processor 210 may execute one or more programs 250 located remotely from system 100. For example, system 100 may access one or more remote programs 250, that, when executed, perform functions related to disclosed embodiments.

Memory 230 may include one or more memory devices that store data and instructions used to perform one or more features of the disclosed embodiments. Memory 230 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. Memory 230 may include software components that, when executed by processor 210, perform one or more processes consistent with the disclosed embodiments. In some embodiments, memory 230 may include a customer survey database 260, a tire information database 270, and a recommendation database 280 for storing related data to enable recommendation device 120 to perform one or more of the processes and functionalities associated with the disclosed embodiments.

Customer survey database 260 may include stored data relating to user surveys, such as for example, survey questions, user survey responses, user persona profile information. For example, in some embodiments, survey questions may be targeted questions that when answered may provide the recommendation device 120 with information on what is important to user's driving experience. Further, questions may be related to vehicle type, daily driving conditions, how much longer the user plans to keep the car, where and how much they drive, local climate data, and lifestyle habits. Tire information database 270 may include stored data relating to vehicles and tires. For example, in some embodiments, tire information database 270 may include information about the user's vehicle including year, make, model, and trim. In some embodiments tire information database 270 may include information about tire fitment (e.g., tire size, load rating, speed rating, etc.), product tier information, product category information etc. Although these databases 260, 270, 280 have been described as being separate databases for the purposes of the present discussion, these databases may alternately be combined into one or more databases.

Recommendation device 120 may also be communicatively connected to one or more memory devices (e.g., databases (not shown)) locally or through a network. Remote memory devices may be configured to store information and may be accessed and/or managed by recommendation device 120. By way of example, such remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

Recommendation device 120 may also include one or more I/O devices 220 that may comprise one or more interfaces for receiving signals or input from devices and providing signals or output to one or more devices that allow data to be received and/or transmitted by recommendation device 120. In exemplary embodiments of the disclosed technology, recommendation device 120 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

While recommendation device 120 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations of the recommendation device 120 may include a greater or lesser number of components than those illustrated.

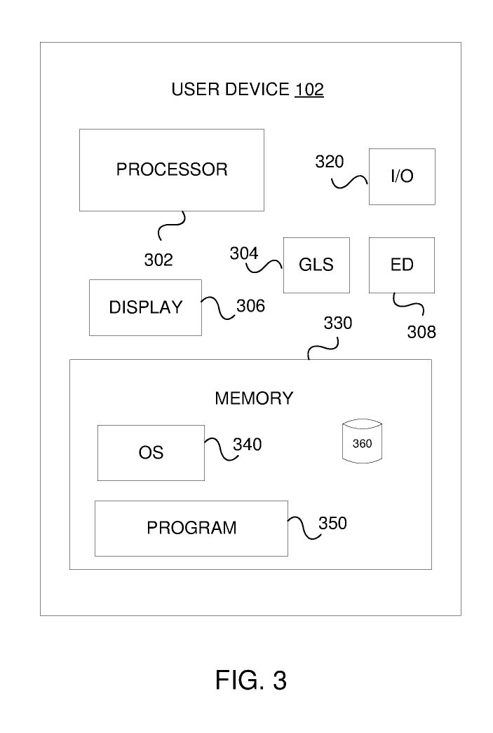

FIG. 3 shows an exemplary interactive embodiment of a user device 102. As shown, user device 102 may include an I/O device 220, a memory 230 containing an OS 240 and a program 250 and all associated components as described above with respect to authentication device 120. User device 102 may also include a recommendation processor 302 for generating user identity verification data, a geographic location sensor (“GLS”) 304 for determining the geographic location of user device 102, a display 306 for displaying digital images, and an environmental data (“ED”) sensor 308 for detecting sensor data. In some embodiments, an environmental data sensor 308 may include, for example but not limited to, a fingerprint scanner, a microphone, and/or a digital camera. In some embodiments, user device 102 may include one or more processors. According to some embodiments, recommendation processor 302 may include all of the features and functions of processor 210 described above.

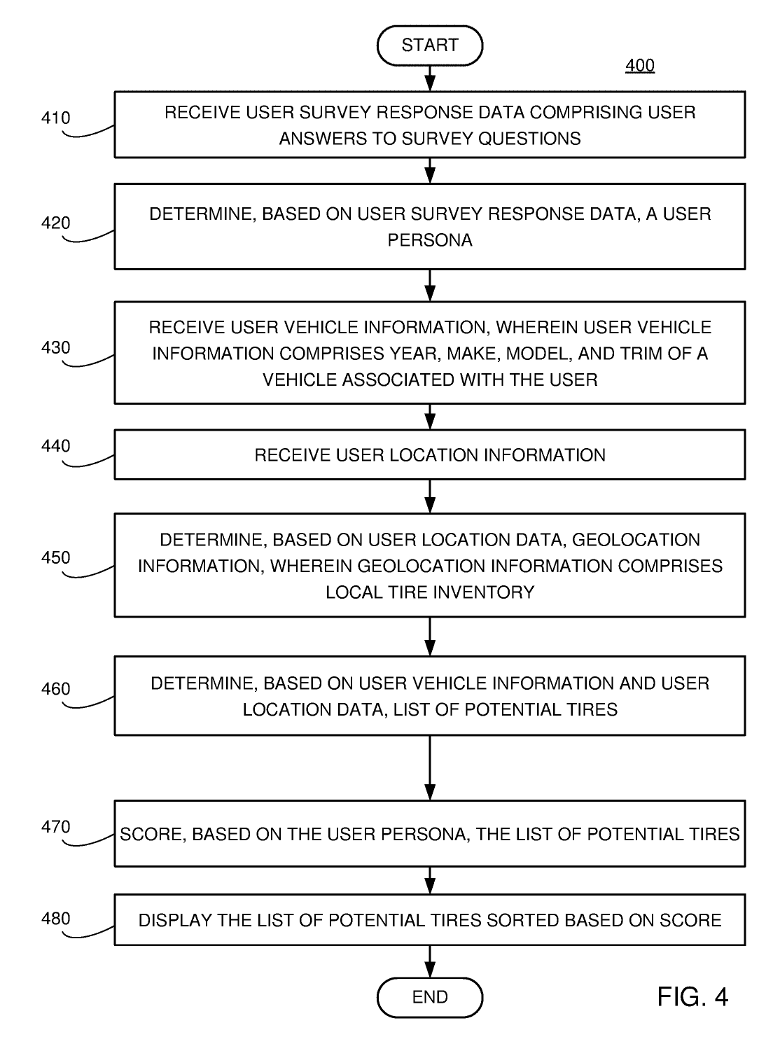

FIG. 4 is a flowchart of method 400 for profiling users and making recommendations for tires to purchase based on the user profile, according to embodiments of the disclosed technology. Method 400 may be performed by recommendation device 120 using processor 210 to execute memory 230. In some embodiments, steps of method 400 may be performed by other elements in system 100, such as user device 102, third-party server 126, web server 110, communication server 112, or transaction server 114. Following method 400, system 100, by recommendation device 120, may determine a user persona based on a user's response to a predetermined set of questions. System 100 my user the determined persona in order to generate, by recommendation device 120, recommendations for tires to be purchased, which in some embodiments may be based on a determined user profile.

As shown in FIG. 4, system 100 may receive 410 user survey response data that includes answers to survey questions. For example, in some embodiments, communication server 112 may receive user survey response data over network 106 from user device 102. According to some embodiments, a user may be given the opportunity to take a quiz to determine their driving persona based on habits and preferences. In some embodiments, the quiz takes the user through a series of questions that ask targeted questions designed to get information as to what is important to the user's driving experience. In some embodiments, questions may be directed towards vehicle type, daily driving conditions, how much longer they plan to keep the car, where and how much they drive, local climate data, lifestyle habits, or a combination of such, though such questions may not appear, at least on the surface, as being directed to such information.

System 100 may determine 420, based on the user survey response data, a user persona for the user. For example, in some embodiments, communication server 112 may determine the contents of user survey response data and may send user survey response data over network 116 to recommendation device 120. In some embodiments, recommendation device 120 may input user survey response data as inputs into an algorithm and based on a pre-determined weighting system may determine a persona that best aligns with the user survey response data. In some embodiments, possible personas may be, for example, commuter, trailblazer, road warrior, zen master, competitor, and exhibitionist. According to some embodiments, a user may be presented with a list of available personas and may be provided with the option to self-select a persona instead of taking a quiz.

As shown in FIG. 4, system 100 may receive 430 user vehicle information, which may include a user's vehicle's year, make, model, and trim, among other information. For example, in some embodiments, communication server 112 may receive user vehicle information over network 106 from user device 102. Additionally, system 100 may receive 440 user location data. For example, in some embodiments, communication server 112 may receive over network 106 user location data from user device 102. In some embodiments, user location data may be data indicating the location (i.e., GPS data, longitude, latitude, triangulated position from cell tower or Wi-Fi access point, city, state, country, time zone, or other relevant information) of user device 102. According to some embodiments, device location data may include unique device characteristics such as time zone, operating system version, browser version, user agent information, IP address, wireless carrier information, internet service provider information, or other data indicating the location or other device characteristic. Further, according to some embodiments, system 100 may automatically determine the user's location based on the user's IP address (e.g., by reading the user's IP address based on the user's Internet history).

System 100 also may determine 450 certain geolocation information, such as local tire inventory or a list of potential tires, based on user location data. For example, in some embodiments, transaction server 114 may transmit user location data over network 106 to third-party server 126. Third-party server 126 may then transmit relevant geolocation data over network 106 back to transaction server 114. Transaction server 114 may determine the contents of the relevant geolocation data and transmit the relevant geolocation data over network 116 to recommendation device 120. According to some embodiments, the system may user geolocation data to obtain relevant information that may include, but is not limited to, local demographic data, local road types, local tire inventory, and local climate data. In some embodiments, local demographic data may include the following information for the location associated with the user location data: average income, average miles driven, average vehicle age, and average vehicle value. In some embodiments, local road types may include the information related to the roads for the local associated with the user location data. For example, in some embodiments, local road types may include city roads, highway roads, rural roads, or off-roads. According to some embodiments, local tire inventory may include the following information for the local associated with the user location data: actual availability of tires and local brand affinity. In some embodiments, local climate data may include the following information for the local associated with the user location data: average temperatures, average precipitation, and average length of seasons.

As further shown in FIG. 4, system 100 may determine 460 a list of potential tires to recommend to the user based on user vehicle information and geolocation information. For example, in some embodiments, recommendation device 120 may compile the requirements of the persona, the tires available to fit the vehicle, and the geographic and weather information. Recommendation device 120 may then generate a list of tires that meet all of the requirements. Upon receiving the list of available tires, system 100 may score 470 the list of potential tires based on the user's persona to determine best options for the user. For example, in some embodiments, recommendation device 120 may score the list of potential tires based on predetermined weighting factors to determine a level of compatibility between the stated requirements and the products. After scoring, system 100 may sort the list via recommendation device 120 based on the respective computed compatibility scores.

Finally, system 100 may output for display 480 the sorted list of potential tires. For example, in some embodiments, recommendation device 120 may send a sorted list of potential tires through network 116 to web server 110. In some embodiments, web server 110 may package and transmit the sorted list and transmit the sorted list over network 106 to user device 102 for display. In certain embodiments, the system may initially display to the user the top three offerings based on the system's 100 determination in addition to the original equipment (OE) (i.e., the tires that originally were included on the vehicle), if the OE is not listed in the top three. According to some embodiments, system 100 may provide the customer the option to view additional offerings and filter by, for example, brand. Additionally, in some embodiments, the system may display to the customer any of the following information: price, attribute compatibility, reviews, and images. Further, in some embodiments, the system may provide to the customer the option to select the type and number of tires needed, schedule installation, and complete the transaction, including payment.

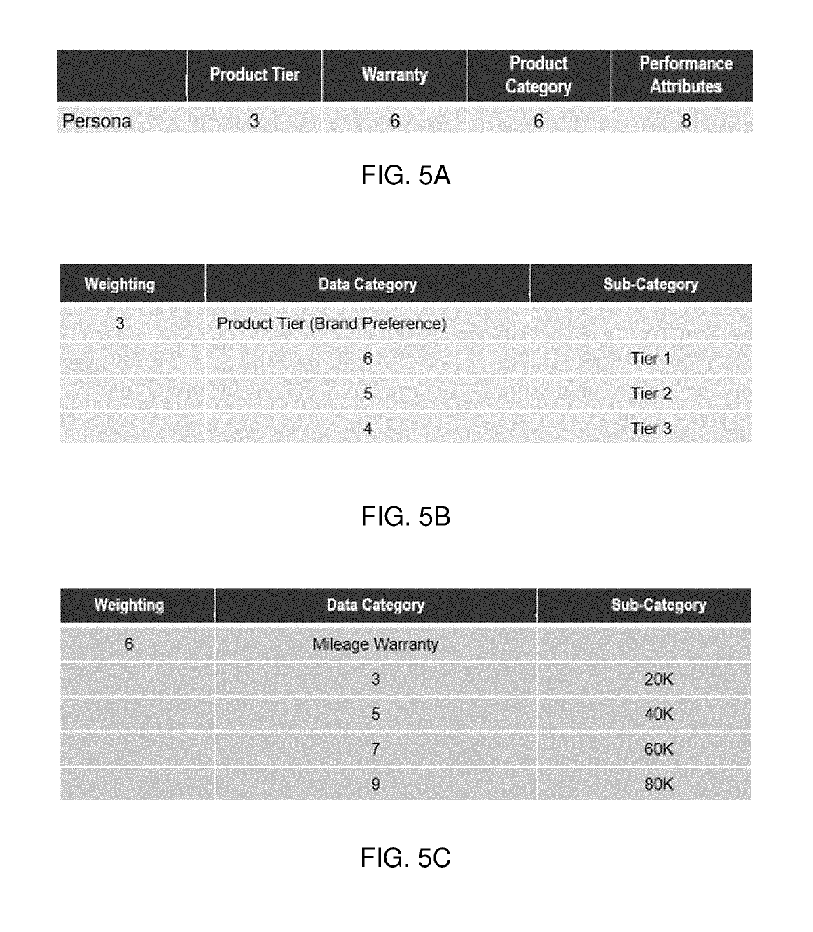

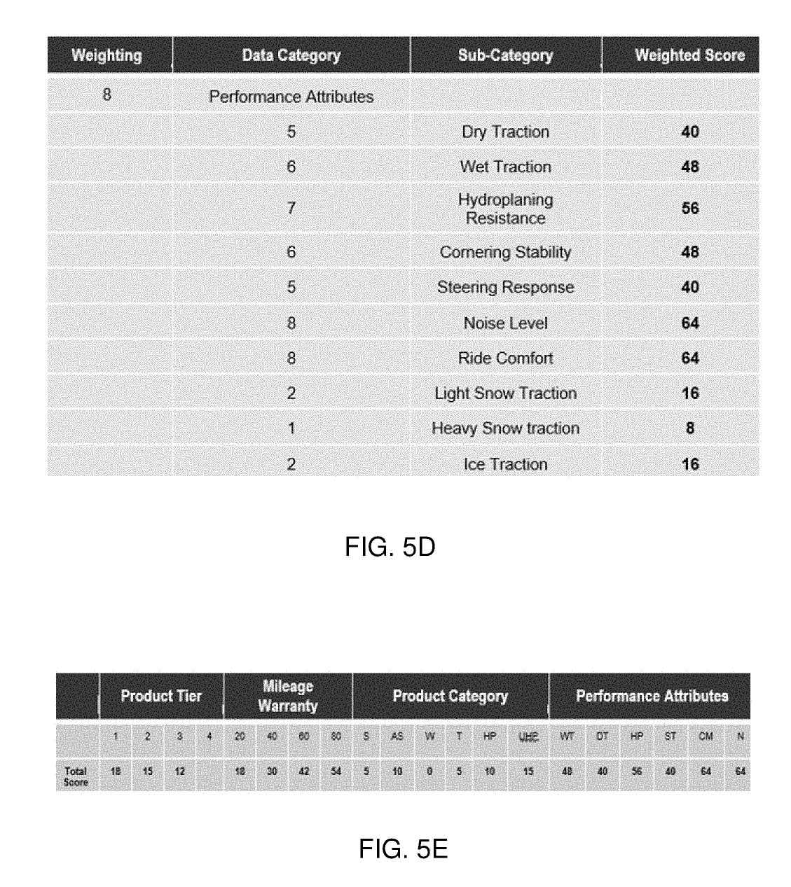

FIGS. 5A-5E depict an example implementation of the disclosed technology for profiling users and recommending tires to purchase. It should be understood that the numeric values are provided for example purposes and are meant to be nonlimiting. FIG. 5A depicts an example of predetermined weights that may be applied to a list of potential tires. So as shown in the first row of FIG. 5A, the user's responses to the quiz questions results in a persona that has a weight of 3 assigned to the “Product Tier” category, a weight of 6 being assigned to the “Warranty” category, a weight of 6 being assigned to the “Product Category” category, and a weight of 8 being assigned to the “Performance attributes category.” So as will be appreciated, such a user may have answered quiz questions in such a way as to indicate that performance attributes and product category are significant to the user and that a product's tier does not matter as much to the user.

FIG. 5B depicts an example of predetermined weights of sub categories of the main product tier category. For example, in some embodiments, and as shown, tires that are classified as product Tier 1 would have a sub score weight of 6, tires that are classified as product Tier 2 would have a sub score weight of 5, and tires that are classified as product Tier 3 would have a sub score weight of 4. FIG. 5C depicts an example of predetermined weights of sub categories of the warranty category. For example, in some embodiments, and as shown, tires that have a 20K mile warranty would have a sub score weight of 3, tires that have a 40K mile warranty would have a sub score weight of 5, tires that have a 60K mile warranty would have a sub score weight of 7, and tires that have an 80K mile warranty would have a sub score weight of 9. FIG. 5D depicts an example of predetermined weights of sub categories of the performance attributes category. For example, in some embodiments, and as shown, tires that have dry traction capabilities would have a sub score weight of 5 and a total weighted score of 40, tires that have wet traction capabilities would have a sub score weight of 6 and a total weighted score of 48, tires that have hydroplaning resistance capabilities would have a sub score weight of 7 and a total weighted score of 56, tires that have cornering stability capabilities would have a sub score weight of 6 and a total weighted score of 48, tires that have steering response capabilities would have a sub score weight of 5 and a total weighted score of 40, tires that have noise level capabilities would have a sub score weight of 8 and a total weighted score of 64, tires that have ride comfort capabilities would have a sub score weight of 8 and a total weighted score of 64, tires that have light snow traction capabilities would have a sub score weight of 2 and a total weighted score of 16, tires that have heavy snow traction capabilities would have a sub score weight of 1 and a total weighted score of 8, and tires that have ice traction capabilities would have a sub score weight of 2 and a total weighted score of 16. As will be appreciated, the figures shown in FIG. 5D illustrate that, in terms of performance attributes, noise level and ride comfort can be considered to be more important than, for example, heavy snow traction.

In some embodiments, system 100 can use the weighted scores and sub scores along with vehicle identification information to evaluate each tire in the fitment list resulting from a user's quiz answers. In some embodiments, the weighted scores above can be multiplied again by a normalization factor to level the results across the various data categories and preserve the relative weightings of each category in relation to the other data categories.

FIG. 5E shows total weighted scores for all attributes based on the persona discussed in FIG. 5A. In FIG. 5E, S=Summer, AS=All-Season, W=Winter, T=Touring, HP=High-Performance, UHP=Ultra-High-Performance, WT=Wet Traction, DT=Dry Traction, HP=Hydroplaning Resistance, ST=Steering Responsiveness, CM=Ride Comfort, and N=Noise Level. Based on the listed values in the chart in FIG. 5E, the person values tires in the first product tier, with a high mileage warranty, and prefers tires in the All-Season-Ultra-High-Performance category, with an emphasis on good wet traction and hydroplaning scores as well as good comfort and noise characteristics. In some embodiments, each potential tire (i.e., the entire tire inventory) may be evaluated against the weighted scores for compatibility. Based on each tire's physical characteristics, each tire may inherit the appropriate score from the weighted results, while its scores in the “Performance Attributes” section can be based on its actual rating values. As mentioned earlier, in some embodiments, each tire's total score may be leveled so that the total number of points in each of the four sections of data category (Product Tire, Mileage Warranty, Product Category, Performance Attributes) is equivalent to preserve relative weightings among the categories.

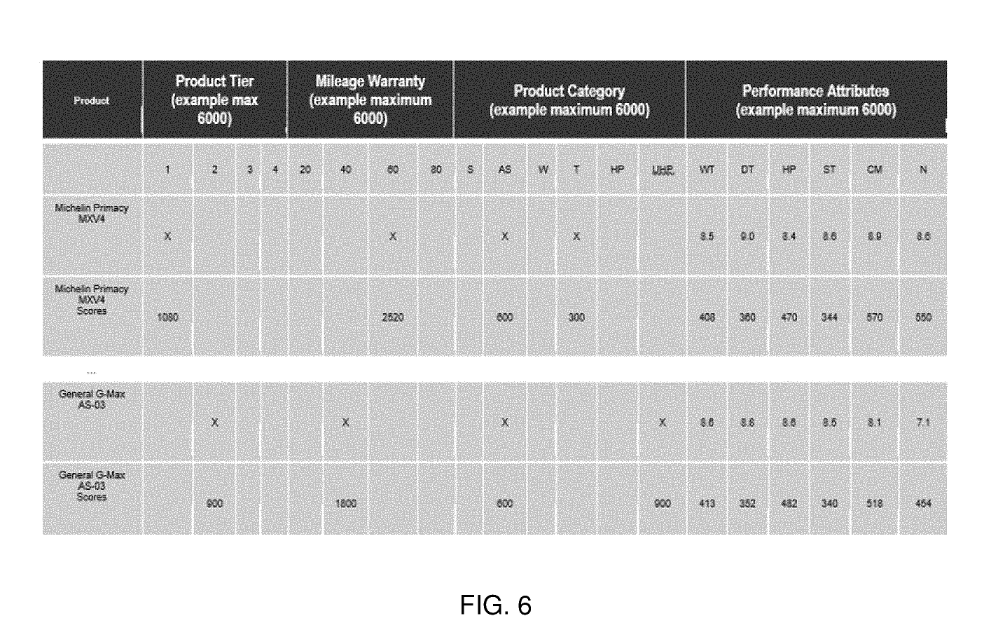

FIG. 6 depicts the resulting metrics for profiling users and recommending tires for purchase, according to aspects of the disclosed technology. In some embodiments, and as shown in the first two rows of the chart in FIG. 6, a Michelin Primacy MXV4 tire may be evaluated and scored according to the previously discussed systems and methods. As shown, the Michelin tire has scores for its various Performance Attributes, but it also gets scores for being a Tier 1 product with a 60K mileage warranty, and for being an All-Season-Touring tire, which are relevant criteria for the persona of the foregoing example. In some embodiments, and as shown in the last two rows of the chart in FIG. 6, General G-Max AS-03 tire may be evaluated and scored according to the previously discussed systems and methods. As shown, the General tire has scores for its various Performance Attributes, but it also gets scores for being a Tier 2 product with a 40K mileage warranty, and for being and All-Season-Ultra-High-Performance tire. The scores for the Michelin and General tires may then be aggregated so that the tires can be sorted based on the aggregated score, as previously discussed.

While certain embodiments of the disclosed technology have been described in connection with what is presently considered to be the most practical embodiments, it is to be understood that the disclosed technology is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the disclosed technology, including the best mode, and also to enable any person skilled in the art to practice certain embodiments of the disclosed technology, including making and using any devices or systems and performing any incorporated methods. The patentable scope of certain embodiments of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for profiling a user and recommending tires based on the determined user profile, comprising:
one or processors; and
a memory in communication with the one or more processors and storing instructions that, when executed by the one or more processors, are configured to cause the system to:
receive, from a user device associated with a user, user survey response data comprising user answers to survey questions;
determine, based on user survey response data, a user persona;
receive, from the user device, user vehicle information, the user vehicle information comprising year, make, model, and trim of a vehicle associated with the user;
receive, from the user device, user location data;
determine, based on user location data, geolocation information, the geolocation information comprising local tire inventory;
determine, based on the user vehicle information and the geolocation information, a list of potential tires;
score, based on the user persona, the list of potential tires; and
responsive to sorting the list of potential tires based on a respective score, output for display on the user device, the sorted list of potential tires.

2. The system of claim 1, wherein the user interacts with the system via a website being accessed on the user device associated with the user.

3. The system of claim 1, wherein the user interacts with the system via a mobile application running on the user device associated with the user.

4. The system of claim 1, wherein the system automatically determines the user's location based on the user's IP address.

5. The system of claim 1, wherein the list of potential tires is sorted based on ascending order of the respective scores.

6. The system of claim 1, wherein the scoring the list of potential tires comprises:
assigning, based on the user persona, a predetermined weight to each of a plurality of scoring categories;
normalizing the predetermined weight for each of the plurality of scoring categories;
determining relevant scoring categories associated with each tire in the list of potential tires; and
aggregating the normalized predetermined weights for each relevant scoring category associated with each tire in the list of potential tires.

7. The system of claim 1, wherein geolocation information further comprises local demographic data, local road type data, local tire inventory, and local climate data.

8. The system of claim 7, wherein determining geolocation information further comprises:
transmitting, to a traffic server, the user location data;
receiving, from the traffic server, local road type data;
transmitting, to a weather server, the user location data; and
receiving, from the weather server, local climate data.

9. A system for profiling a user and recommending tires based on the determined user profile, comprising:
one or processors; and
a memory in communication with the one or more processors and storing instructions that, when executed by the one or more processors, are configured to cause the system to:
output, for display at a user device associated with a user, user persona data that comprises a plurality of personas.
receive, from the user device (i) user persona selection data comprising a user's chosen persona, (ii) user vehicle information, the user vehicle information comprising year, make, model, and trim of a vehicle associated with the user, and (iii) user location data;
determine, based at least in part on the user location data, geolocation information, the geolocation information including local tire inventory;
determine, based at least in part on the user vehicle information and the geolocation information, a list of potential tires;
score, based on the user persona selection data, the list of potential tires; and
responsive to sorting a list of potential tires based on a respective score, output, for display at the user device, a sorted list of potential tires.

10. The system of claim 9, wherein the user interacts with the system on a website being accessed on the user device associated with the user.

11. The system of claim 9, wherein the user interacts with the system through a mobile application accessed on the user device associated with the user.

12. The system of claim 9, wherein the system automatically determines the user's location based on the user's IP address.

13. The system of claim 9, wherein the list of potential tires is sorted based on ascending order of the respective scores.

14. The system of claim 9, wherein the scoring the list of potential tires comprises:
assigning, based on the user persona, a predetermined weight to each of a plurality of scoring categories;
normalizing the predetermined weight for each of the plurality of scoring categories;
determining relevant scoring categories associated with each tire in the list of potential tires; and
aggregating the normalized predetermined weights for each relevant scoring category associated with each tire in the list of potential tires.

15. The system of claim 9, wherein geolocation information further comprises local demographic data, local road type data, local tire inventory, and local climate data.

16. The system of claim 15, wherein determining geolocation information further comprises:
transmitting, to a traffic server, the user location data;
receiving, from the traffic server, local road type data;
transmitting, to a weather server, the user location data; and
receiving, from the weather server, local climate data.

17. A method for profiling a user and recommending tires based on the determined user profile, the method comprising:
receiving, from a user device, user survey response data, the user survey response data including user answers to survey questions;
determining, based at least in part on the user survey response data, a user persona;
receiving, from the user device, (i) user vehicle information, the user vehicle information including year, make, model, and trim of a vehicle associated with the user, and (ii) user location data;
determining, based at least in part on user location data, geolocation information, the geolocation information comprising a local tire inventory;
determining, based at least in part on the user vehicle information and the geolocation information, a list of potential tires;
scoring, based at least in part on the user persona, the list of potential tires; and
responsive to sorting a list of potential tires based on a respective score, outputting, for display on the user device, a sorted list of potential tires.

18. The method of claim 17, wherein scoring the list of potential tires comprises:
assigning, based on the user persona, a predetermined weight to each of a plurality of scoring categories;
normalizing the predetermined weight for each of the plurality of scoring categories;
determining relevant scoring categories associated with each tire in the list of potential tires; and
aggregating the normalized predetermined weights for each relevant scoring category associated with each tire in the list of potential tires.

19. The method of claim 17, wherein geolocation information further comprises local demographic data, local road type data, local tire inventory, and local climate data.

20. The method of claim 19, wherein determining geolocation information further comprises:
transmitting, to a traffic server, the user location data;
receiving, from the traffic server, local road type data;
transmitting, to a weather server, the user location data; and
receiving, from the weather server, local climate data.
